(19) United States
(12) Patent Application Publication
(10) Pub. No.: US 2010/0283181 A1
(43) Pub. Date: Nov. 11, 2010

(54) MOULD SYSTEM FOR MAKING A PARTITION IN A CARDBOARD-BASED CONTAINER

(76) Inventors: Päivi Määttä, Imatra (FI); Panu Tanninen, Rauha (FI); Olavi Pirttiniemi, Jarvela (FI); Noora Nylander, Lahti (FI); Jalliina Järvinen, Lahti (FI); Teemu Karhu, Imatra (FI)

Correspondence Address: BIRCH STEWART KOLASCH & BIRCH, PO BOX 747, FALLS CHURCH, VA, 22040-0747, US

(21) Appl. No.: 12/863,567

(22) PCT Filed: Aug. 12, 2009
(86) PCT No.: PCT/FI09/50658

§ 371 Date: Jul. 19, 2010

(30) Foreign Application Priority Data
Aug. 12, 2008 (FI) 20080463

(51) Int. Cl. B29C 45/14; B28B 7/24

(52) U.S. Cl. 264/266; 425/451.9

(57) ABSTRACT

The invention relates to a mould system (1) for making a partition in a cardboard-based container, whereby the mould system includes a moving mould half (10) and a stationary mould half (20), which are located opposite to each other, the mould system (1) enabling the manufacture of a container (500) that comprises a bottom (57) that is pressed from a cardboard blank and walls (59) connected to the bottom, and a rim (50) that is at least partly cast of plastic and connected to the upper edge of the walls, encircling the walls, whereby the mould half (10) that is movable with respect to the stationary mould half (20) includes at least a core plate (4) that is provided with a core (41), a plate-like seal ring (5), which is movable with respect to the core (41) and comprises a seal surface (5a) and surrounds the core (41), and a collar ring (6), which can be fitted between the core (41) and the seal ring (5) and by which the rim (50) can be made on the container and which can be moved with respect to both the seal ring (5) and the core (41); and the stationary mould half (40) includes at least a mould plate (7) that is provided with a mould cavity (71) and a seal surface (7a). In the mould system (1) according to the invention, at least one recess (420) is formed in the core (41) in the longitudinal direction of the core, dividing, in the lateral direction, the core (41) or the forming part of the core (41) that is pressed to the mould cavity, and facing the end (41b) of the core on the side of the mould cavity, the recess enabling the making of a plastic partition (V) that extends upwards from the bottom (57) of the cardboard-based container (500), when the said recess (420) is placed against the cardboard blank that lies on top of the mould cavity.

The invention relates to a mould system according to the preamble of Claim 1 for making a partition in a cardboard-based container, the mould system including a movable mould half and a stationary mould half, which mould halves are located opposite to each other; and the mould system can be used to manufacture a container that comprises a bottom, which is pressed from a cardboard blank, walls that are connected to the bottom and a (plastic) rim that is at least partly cast of plastic and connected to the upper edge of the walls, encircling the walls; on the container bottom, there are one or more partitions, which are at least partly made of plastic and which divide the inside of the container into two or more sections.

In food industry, in particular, so-called tray packages are used as storage packages, consisting of lidded containers that have a bottom, walls that encircle the bottom and extend upwards, and a rim that encircles the upper edge of the walls and extends outwards. The container is closed with a lid that is connected to the rim. In such containers, the material of the container bottom and walls often comprise cardboard, on top of which plastic and/or metal layers may be added, which change the steam and/or oxygen transmission properties of the cardboard, depending on the application.

Generally, such a so-called tray package is used for storing foodstuffs, whereby it is closed hermetically by the lid. To be able to attach the lid to the package, the edge of the container that is used as tray package must be provided with a horizontal rim, which protrudes from the upper end of the side walls and encircles the package. On the upper surface of the rim, there is usually a suitable coating, by means of which the lid can be fastened tightly to the package. For example, it is very common to use heat-sealable plastic materials for fastening the lid part to the package. As examples of food packages and packaging materials used therein, among others, the patent specifications WO-03/033258, EP-1289856, WO-00/21854 and U.S. Pat. No. 5,425,972 could be mentioned.

Such a container with the shape of a tray, comprising a bottom pressed from a cardboard blank, walls connected to the bottom and a rim that is at least partly cast of plastic and connected to the upper edge of the walls, encircling the walls, can be formed by various methods. The published application Fl 20070973 describes a manufacturing method of a tray package, wherein the container is formed from a straight cardboard blank by pressing to shape in a mould system, which includes a movable mould half and a stationary mould half, which are located opposite to each other, whereby the mould that is movable with respect to the stationary mould includes at least a core plate provided with a core, a plate-like seal ring, which is movable with respect to the core and has a seal surface and surrounds the core, and a collar ring, which can be moved with respect to the core and the seal ring and fitted between the same and which can be used to form the rim on the container; and the stationary mould half includes at least a base plate provided with a mould cavity and a seal surface.

The cardboard blank that is pressed to shape by such a mould system is brought on top of the mould cavity of the stationary mould half, the core of the movable mould half settles into the mould cavity, and the cardboard blank remaining between the core and the mould cavity is moulded into a container that has the shape of a tray. At the end stage of the compression moulding, a rim that extends sideways is cast of a plastic material on the upper part of the side walls of the package, when the mould is kept closed in such a way that a mould cavity corresponding to the rim is formed by moving a counter surface inside the mould system backwards from a surface opposite to it, after which the casting material is introduced into the mould cavity. In the cavity, the material solidifies into a fixed rim, after which the mould is opened and the finished container-shape package is removed from the mould.

With the prior art above as basis, the object of the applicant was to provide a more versatile manufacturing method of tray packages, wherein the same mould system could be used to manufacture various containers, which are used as tray packages and wherein the container body could be provided with various embossed or inlaid shapes, or partitions could be formed on the container bottom, dividing the inside of the container into two or more sections.

Surprisingly, it has now been observed that by modifying the mould cavity and/or the forming core of the mould system described above by various inserts or attachment parts that are detachably placed in the mould cavity and/or the forming core, the body of the container that is manufactured can be modified as desired.

To be more precise, the invention relates to a mould system according to Claim 1 for manufacturing a cardboard-based container. Such a mould system includes a movable mould half and a stationary mould half, which are located opposite to each other; the mould system can be used to manufacture a container, which comprises a bottom that is pressed from a cardboard blank, walls that are connected to the bottom and a rim that is at least partly cast of plastic and connected to the upper part of the walls, encircling the walls, whereby the mould half that is movable with respect to the stationary mould half includes at least a core plate provided with a core, a plate-like seal ring that is movable with respect to the core and comprises a seal surface and surrounds the core, and a collar ring, which can be fitted between the core and the seal ring and which can be used to form the rim on the container and which can be moved with respect to both the seal ring and the core; and the stationary mould half includes at least a mould plate that is provided with a mould cavity and a seal surface. In the mould system, at least one recess is formed in the core, dividing, in the lateral direction, the core or the forming part of the core that is pressed to the mould cavity, and enabling the formation of a partition, which extends upwards from the container bottom, by pouring plastic into the recess after the recess is arranged on top of the bottom of the cardboard blank that is located on the container bottom.

The one-sided inlaid or embossed patterns or shapes of the body refer to the recesses or bulges that are formed on one surface of the body only. The two-sided inlaid or embossed patterns or shapes of the body refer to the recesses or bulges that go through the body that is pressed from cardboard, whereby a recess on one side of the body always corresponds to a bulge of a similar size and shape on the opposite side of the body.

In the method according to the invention, the cardboard blank is pressed between the forming core and the mould cavity to provide the container bottom and walls that encircle the bottom, whereafter a flange-like rim, which encircles the walls and at least partly consists of plastic, is formed on the upper edge of the walls by casting and, in addition, a partition wall that attaches to the container body is made by introducing molten plastic into the recess of the core that extends to the cardboard blank that is pressed to the bottom of the mould cavity, through casting conduits that are arranged through the body of the front mould.

The invention is based on the fact that when plastic partitions are to be cast in the container that is made, the basic part of the forming core is provided with an attachment part that comprises a recess, which has the shape and dimensions of the intended wall, or the entire forming core on the core plate is replaced with such a forming core that comprises a recess, which has the shape and dimensions of the intended wall.

Earlier, it has been necessary to make the partitions of containers by a separate tool. Now, by providing the part of the basic core that penetrates inside the mould cavity with a suitable attachment part, which has the shape and dimensions of the partition, the partition can be cast immediately after the cardboard blank is pressed to shape without opening the mould. In this way, the mould system becomes modular and changes are easy and simple to make without changing the operation of the entire mould system.

Depending on the other changes that are to be made in the cardboard-based body, i.e., the container bottom and walls, the forming core on the core plate is replaced or detachable inserts or attachment parts, which change the forming core and/or its operation and shape, are connected on top of the forming core or to the bottom of the mould cavity. The inserts, which are provided with bulges and inlays of the surface and connected to the mould cavity or the forming core, correspondingly shape the cardboard blank, when the forming core is pressed to the bottom of the mould cavity at the forming stage of the body. The inserts or the attachment part of the core can also be used to either increase or decrease the depth of the container, i.e., the distance of the bottom from the rim.

The patent specification US 2007/0267374 discloses a cardboard-based container, in which plastic partitions are formed by a mould system. However, the specification in question does not give a more specific description of any kind about the actual mould system that provides the partitions; it might be, e.g., a system comprising two cores with a gap at the spot of the partition. Furthermore, it is pointed out that the manufacturing method described in the patent specification mentioned above considerably differs from the one considered advantageous in this application; among others, the said manufacturing method cannot be used to provide the cardboard-based containers with wide plastic rims, as the casting cavity therein is already formed during the moulding of the blank, whereby the retention of the edges of the cardboard, which ensures an even creasing, stops too early. In the invention, the cardboard blank is retained between the seal surface of the seal ring and the seal surface of the collar ring and the seal surface of the mould plate opposite to them, at least until the cardboard blank has slid into the mould cavity, and the casting cavity is not made in the mould system until after this to provide the flange-like rim that at least partly consists of plastic and encircles the walls of the container. The even creasing is more reliable in providing a gas-tight tray, as plastic fills more evenly the spot, where the cardboard and the plastic overlap.

The preferred embodiments of the invention are illustrated by the appended figures, their description also disclosing other advantages provided by the invention.

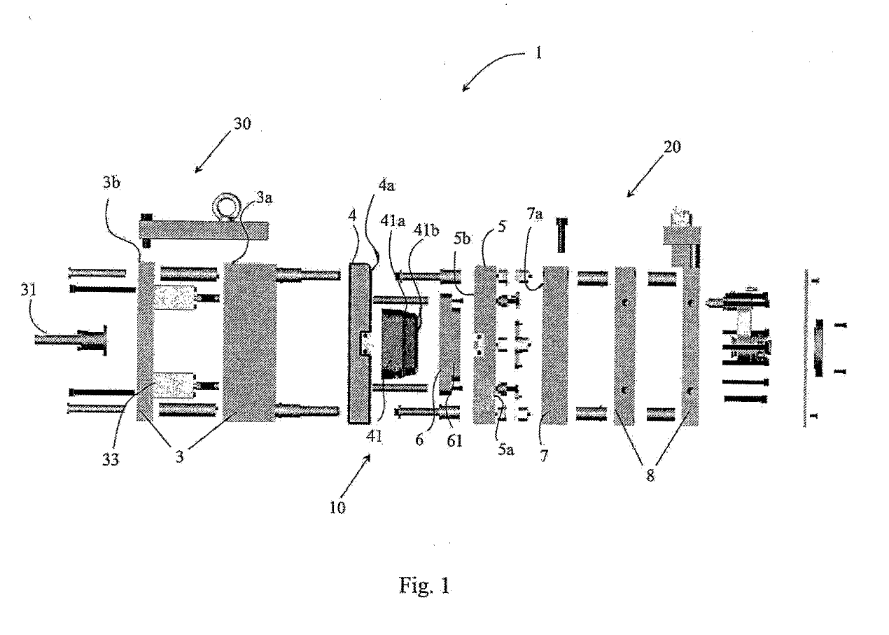

FIG. 1 shows an exploded, cross-sectional side view of the mould system.

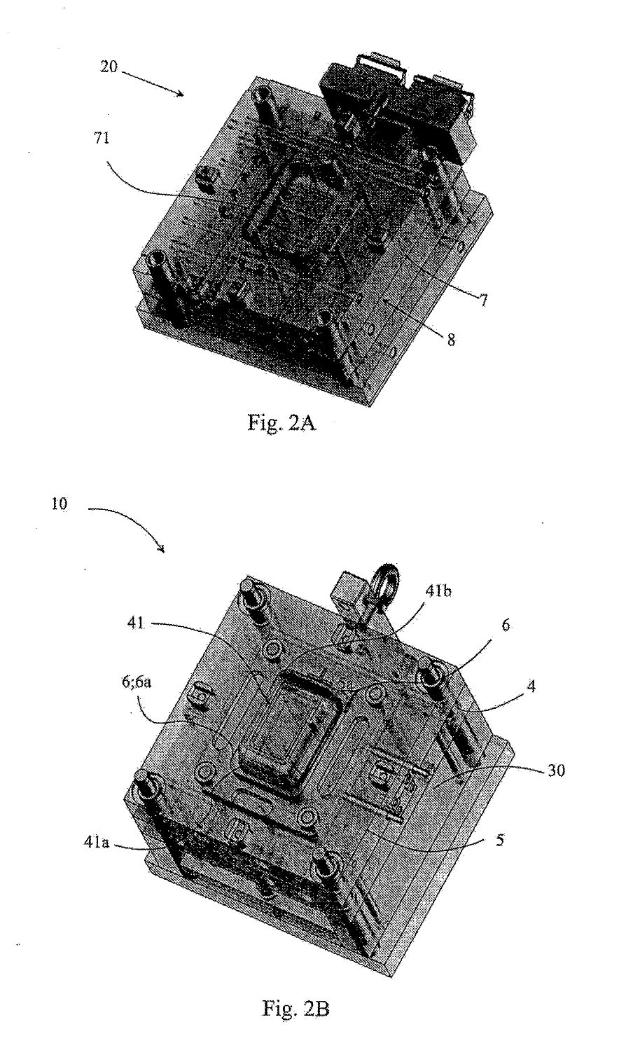

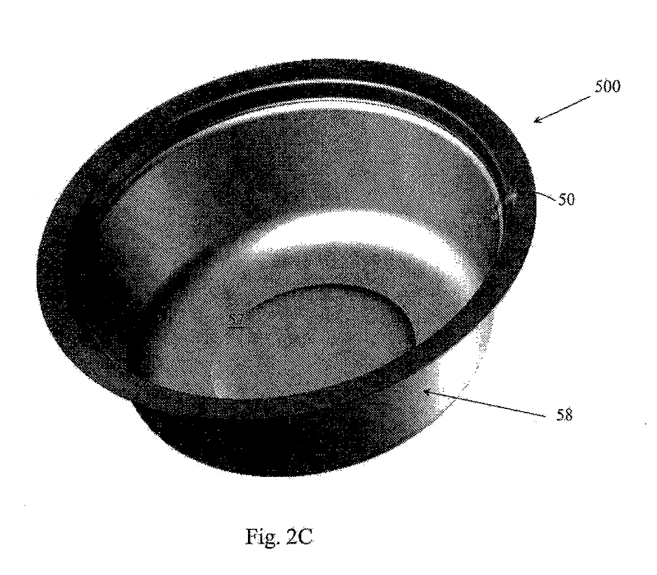

FIGS. 2A and 2B show a perspective view of a mould system according to the prior art.

FIG. 2C shows a perspective view of a container provided by a known mould system.

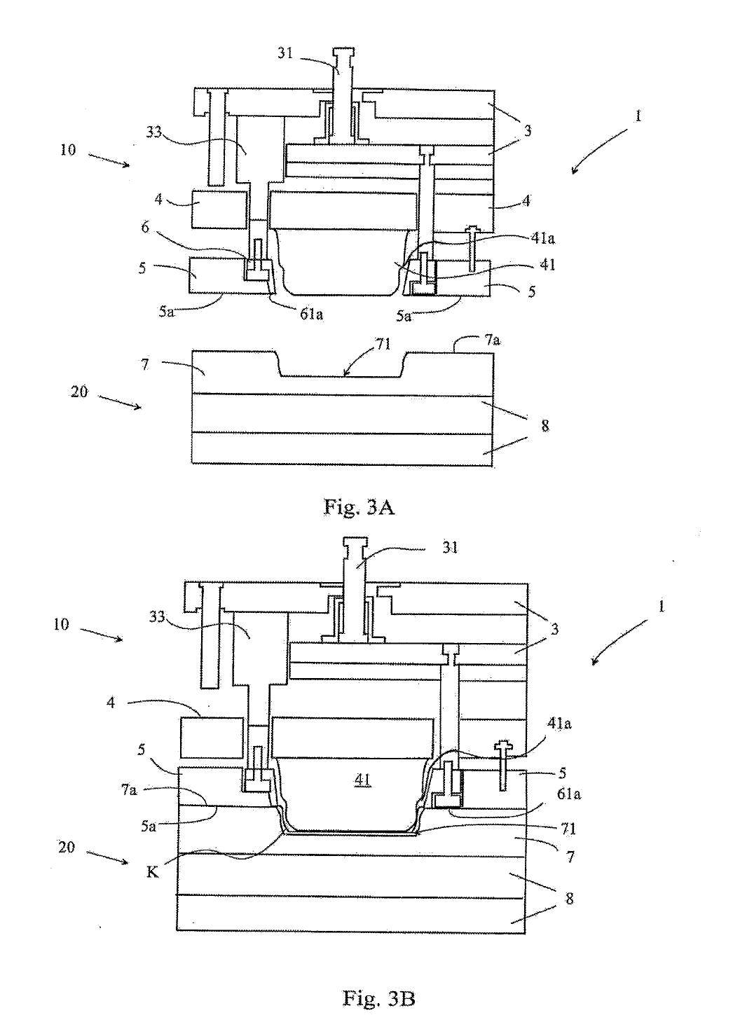

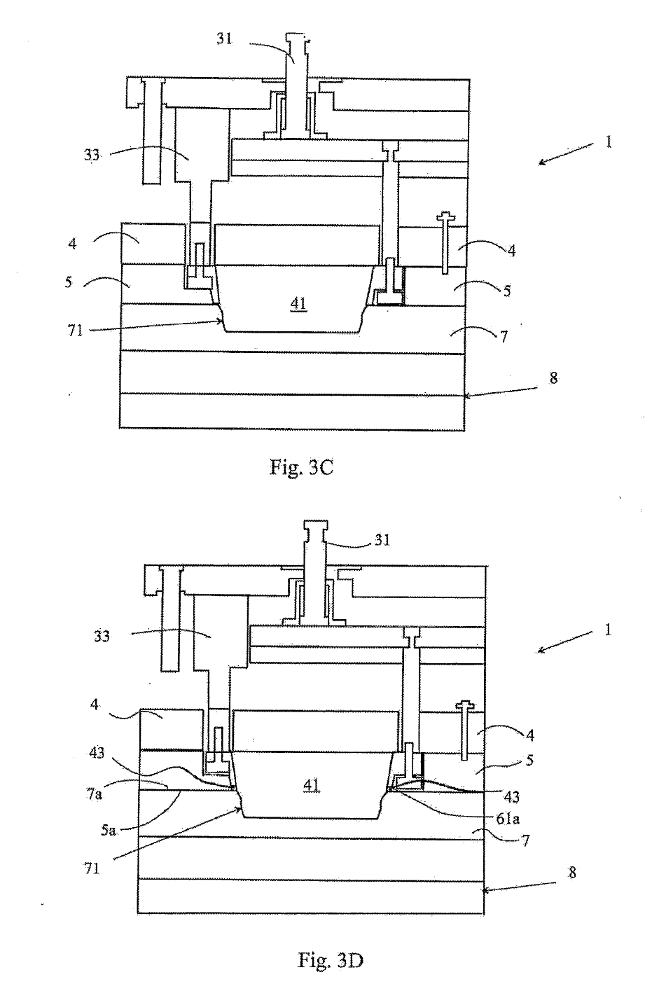

FIGS. 3A-3D show a longitudinal section of the operation of the mould system at the manufacturing stages of the various parts of the container.

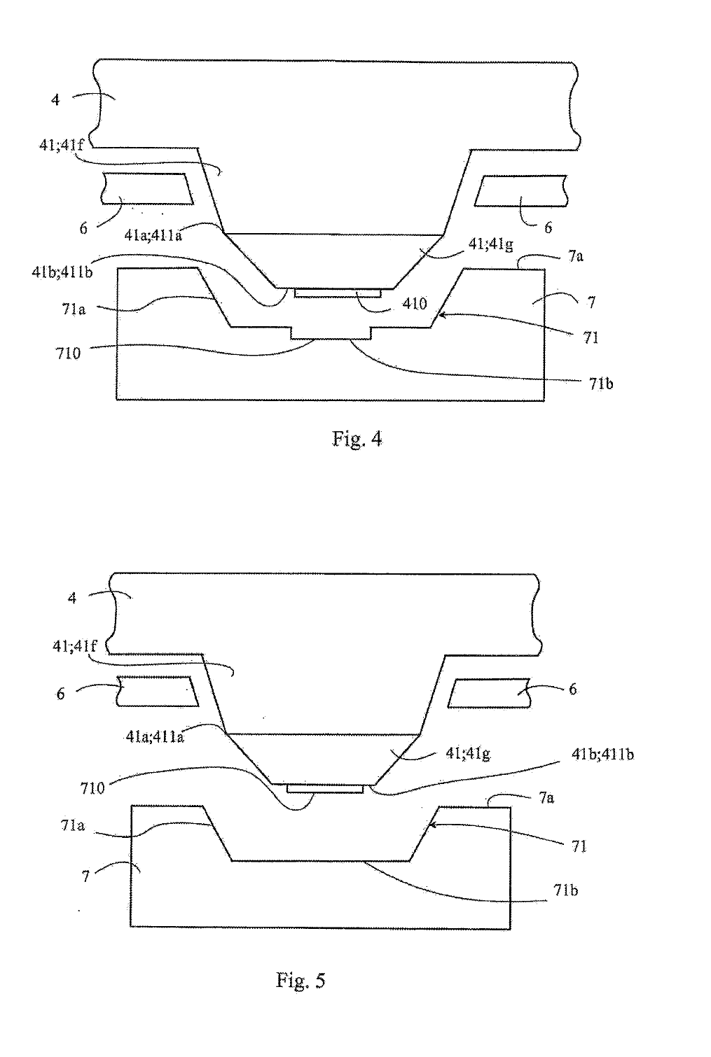

FIG. 4 shows a side view of the longitudinal section of the forming core and the mould cavity, each comprising an insert that shapes the container body.

FIG. 5 shows a side view of the longitudinal section of the forming core and the mould cavity, only one of them comprising the insert that shapes the container body.

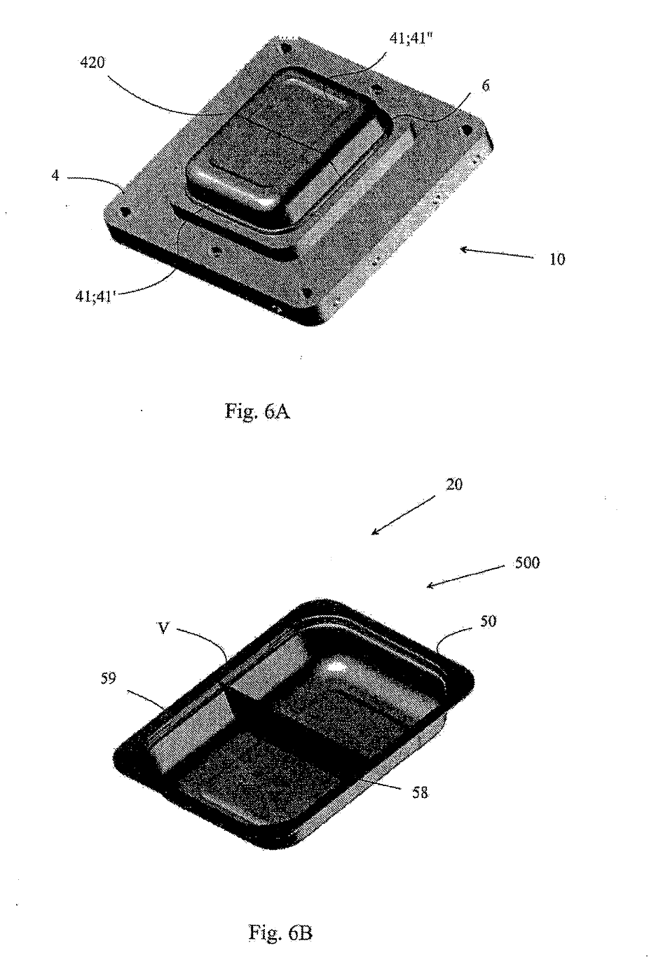

FIG. 6A shows a perspective view of the collar ring and the core that comprises a recess for forming the wall.

FIG. 6B shows a perspective view of a container made by the core according to FIG. 6A.

In the following, the mould system 1 is essentially described first and the operation of the mould system 1 by means of FIGS. 1-3. Regarding the collar ring and the seal ring, the mould systems shown in FIGS. 2A and 2B are not the same as those used in the invention, but they can illustrate the basic structure of the mould system according to the invention.

FIG. 1 shows an exploded view of the main parts of the mould system according to the invention as viewed from the side and in cross section. The mould system 1 includes a movable mould half 10 or “rear mould” and a stationary mould half 20 or “front mould”. The main parts of the movable mould half 10 comprise an ejection part 30 that comprises an ejection bar 31 and the two-piece body 3 of the ejection part, comprising between the parts 3a, 3b of the body, a pneumatic actuator 33 for providing compression between the mould halves 10 and 20. The movable mould half 10 further includes a plate-like seal ring 5, a plate-like collar ring 6 and a core plate 4, to which a (forming) core 41 is attached. The stationary mould half 20 includes a core plate 7, which comprises a mould cavity 71, against which the planar cardboard blank is shaped and which determines the general shape of the package (bottom, shape of side walls extending from bottom, inclination of walls, roundings etc.). The cardboard blank herein refers to a cardboard blank or a cardboard-based blank, wherein the cardboard is possibly coated with layers of plastic or metal to change its barrier properties. Furthermore, the stationary mould half 20 includes a mould frame 8, through which casting conduits are conveyed to the casting spot of the rim in a manner better shown in FIG. 2B.

The seal ring 5 is located annularly around the forming core 41. A collar ring 6, which is movable in the depth direction with respect to the seal ring 5 and the forming core 41, can be arranged between the seal ring 5 and the forming core 41. The depth direction herein refers to the direction perpendicular to the surface 4a of the core plate 4. The seal ring 5 comprises a seal surface 5a, which becomes flush with the face 41a of the moulding part of the core 41 at the end of the compression. The face of the moulding part refers to the part of the core 41, which comes to the plane of the rim of the formed container, i.e., about to the plane of the seal surface 7a of the mould plate 7 and, at the same time, of the upper edge of the mould cavity 71. The moulding part of the forming core 41 shown in FIG. 1 is the part of the core 41, which can be fitted into the mould cavity 71. The moulding part of the forming core 4 shown in FIG. 1 and the corresponding mould cavity 71 have cross-sectional profiles of the shape of a rounded rectangle, whereby they can provide, correspondingly, a container that has a cross section of a rounded rectangle, which is shown, e.g., in FIG. 5A. The cross-sectional profiles of the mould cavity, forming core and container refer to the cross sections as examined in the depth direction of the mould system 1, i.e., perpendicular to the surface planes of the mould plate 7 and the core plate 4. If the cross-sectional profiles of the moulding part of the forming core and the mould cavity are changed, e.g., into the form of a circle, containers with a circular cross section are obtained, respectively, as shown, e.g., in FIG. 2C.

The seal surface 5a of the seal ring 5 is opposite to the corresponding seal surface 7a of the mould plate 7 that surrounds the mould cavity 71 of the front mould 20. The core 41 is further surrounded by the collar ring 6, which is capable of carrying out a short reciprocating motion with respect to the seal surface 5a of the seal ring 5, and the face 61a of the collar 61 of the collar ring 6 that is turned to the stationary mould half 20 can be moved to the plane of the seal surface 5a of the seal ring 5 and to a very short distance backwards from it.

FIG. 2A shows the stationary mould half 20 that is used in a known mould system 1B and FIG. 2B shows the corresponding movable mould half. Regarding its functions and its mould structure, this mould system 1B is of the same type as the one according to the invention, its structure mainly deviating from the mould system according to the invention with respect to the structure of the seal ring 5 that surrounds the core 41 and of the collar ring 6. In the stationary mould half 20, in its front, there is a mould plate 7 that comprises a recess with the shape of a tray, i.e., the mould cavity 71. The mould plate 7 of the stationary mould half 20 is attached to the mould frame 8, through which the casting conduits are introduced. The movable mould half 10, in turn, comprises the forming core 41 in the front, which is attached to the core plate 4 below the same. The core plate 4 is attached to the ejection part 30 of the movable mould half 10. The core 41 is surrounded by the plate-like collar ring 6, which extends to the plane of the face 41a of the core moulding part and the seal surface 6a of which is flush with the face of the core, and by the plate-like seal ring 5, which comprises the seal surface 5a and is located outside the collar ring and limited to the collar ring.

FIGS. 3A-3B show a cross-sectional side view of the mould system 1 according to the invention, its mould halves being the same as those described above in connection with FIGS. 1, 2A and 2B. The mould system 1 is used for forming the tray package, starting from pressing the package and ending in casting the rim. The mould system 1 comprises a compression moulding and casting mould, which is formed from two mould halves 10, 20 and the purpose of which is, at a first stage, to mould a container-shape tray package from an essentially straight and uniform cardboard blank K. A casting function is also integrated into the mould system 1 for casting a rim 50 on the edges of the walls of the package 500 that is shaped by compression.

When the seal surface 61a of the collar 61 of the collar ring 6, i.e., the face 61a that is turned to the stationary mould half 20 is flush with the seal surface 5a of the seal ring 5, a common seal surface is formed by the seal surface 5a of the seal ring and the face or the seal surface 61 of the collar 61. When the mould is closed (the mould halves 10 and 20 are brought together) according to FIGS. 3B-3D, the seal surface 7a of the mould plate 7 of the stationary mould half 20 and the common seal surface 5a, 61a of the movable mould half 10 come against each other, so that the cardboard blank K to be shaped remains between them. The pneumatic actuator 33 between the parts 3a, 3b of the body 3 of the ejection part 30 is connected to the collar ring 6 and it pressurizes, through the collar ring 6, the seal ring 5 and, thus, the common seal surface 5a, 61a of the movable mould half 10 to provide a holding force between the mould halves 10 and 20, i.e., between the common seal surface 5a, 61a and the seal surface 7a of the stationary mould half. The main part of the compression or holding force exerted on the seal surface 7a and, besides, on the cardboard blank K between the seal surfaces 7a and 10a, is generated by the seal surface 5a of the seal ring 5, but the seal surface 61a of the collar 61 of the collar ring also exerts holding force on the cardboard blank K. The holding force can be adjusted by means of the actuator 33, such as a compressed air cylinder, which works on a pressure medium. The collar ring 6 is located inside the ejection part 3 between the seal ring 5 and the core 41.

The two-piece body 3 of the ejection part 30 and the core plate 4 that comprises the core 41 can be moved by the ejection bar 31 in the depth direction with respect to the stationary mould half 20, whereby the depth direction refers to the same as above. The movable mould half 10 thus moves between a front position (shown in FIG. 3A) and a rear position (shown in FIGS. 3B-3D).

At the compression stage, the movable mould half 10 in the mould system presses the cardboard blank K to the mould cavity 71 of the mould plate 7 of the stationary mould half 20. For this, the movable mould half comprises the forming core 41 that is located on the core plate 4, its forming part fitting into the above-mentioned mould cavity 71 up to the face 41a of the core, so that the cardboard blank is pressed between the core 41 and the cavity 71, obtaining its tray shape. The movable mould half 10 is arranged to move with respect to the stationary mould to close and open the mould by arrangements that are not described herein in detail.

FIG. 3A shows the mould system 1 before closing the mould. The cardboard blank K is brought by a robot to the small holders (not shown) on the mould plate 7 of the stationary mould half 20. After this, the mould is closed, i.e., the core 41 settles into the mould cavity 71 and the cardboard blank K remaining between them is pressed into a tray-shape container.

The stage, at which the core 41 begins to shape the blank after settling into the cavity 71, is shown in FIG. 3B. The seal surfaces, i.e., the seal surface 5a of the seal ring and the seal surface 61a of the collar ring lean on the cardboard blank K by the force of the actuator 33 and retain the blank K at its edges at the compression stage between the said seal surfaces 5a and 61a and the seal surface 7a of the mould plate 7 of the stationary mould half.

FIG. 3C shows a situation, where the mould is fully closed, the mould halves 10 and 20 being pressed against each other and the cardboard blank K between them is pressed into a tray, so that the upper edge of the side walls of the tray is flush with the seal surface 61a of the collar ring 6 or slightly in front of it. The last holding force on the edges of the blank is caused by the face 61a of the collar 61 of the collar ring 6, against which there is the seal surface 7a of the mould plate that surrounds the cavity 71 of the stationary mould half.

FIG. 3D shows a situation, where the mould is still closed, but the collar ring 6 has moved a short distance backwards from the seal surface 71a of the stationary mould half 20, i.e., in the direction of the ejection part 3 of the movable mould half 10. The movement is provided by an actuator performing precise movements, e.g., by pulling the ejection bar 31 by an ejection motor. A small casting cavity 43 remains then between the seal surface 7a that surrounds the cavity 71, the seal surface 5a of the seal ring 5, the face 61a of the collar 61 of the collar ring 6 and the face 41a of the core 41, the casting cavity being in contact with the outer edge of the tray, encircling the tray annularly. When the molten plastic material is fed into this casting cavity 43, it forms a flange-like rim that extends outwards from the side walls of the tray. Due to its shape, the collar ring 6 is tightened against the forming core 41 to ensure the tightness of the casting cavity 43. The injection channel of the casting material is arranged through the mould frame 8 of the stationary mould half 20 and the plastic to be cast moves through there to the casting cavity 43. The injection channels can also be arranged to arrive in the injection cavity in another manner, depending on the structure of the container that is shaped.

After the molten plastic material has solidified in the casting cavity 43, the mould can be opened to its open position again. The ejection part 3 is then still in the rear position. When the ejection part 3 is pushed by the ejection rod 31 to the front position, it removes the finished container T from the movable mould half 10 and, at the same time, the collar ring 6 can be moved to the front position again, i.e., the position shown in FIG. 3A is reassumed. The seal surface 7a of the mould plate 7 of the front mould 20 then works as ejection surface, against which the ejection bar 31 pushes, when the finished container is removed from the mould. After this, the robot takes the finished container out and replaces it with a new blank K, after which the working phases are repeated as above.

By using as mould cavity, a cavity suitable for a container with a round bottom, and by adapting the shape of the moulding part of the forming core so as to fit the shape of the mould cavity in question, the mould system described above can be used to make, e.g., the container 500 shown in FIG. 2C, comprising a body 58 that is compression-moulded from the cardboard blank and includes a round bottom 57 and upward-extending walls 59 that are connected to the bottom 57. The flange-like plastic rim 50 extending outwards is cast on the upper edge of the walls 59.

When the container shown in FIG. 2C is to be moulded by forming two-sided decorative or functional embossed or inlaid shapes to its body 58 that is pressed from the cardboard blank, i.e., the bottom 57 or walls 59, this can be carried out by changing the forming core that is used in the mould system according to the invention and the corresponding mould cavity 71, according to FIG. 4. FIG. 4 shows schematically the forming core 41, which is attached to the core plate 4 and consists of two parts; a basic part 41f, which is attached to the core plate 4 of the forming core, and an attachment part 41g of the core, which is attached to the said basic part. A projection 410 is connected to the outer edge 411b of the attachment part 41g, which at the same time works as the outer edge 41b of the core, the projection being used as an insert and directed downwards from the plane of the outer edge of the core, i.e., perpendicular to the direction of the plane of the seal surface 7a of the mould plate 7. FIG. 4 also shows the collar ring 6, which is located below the core plate 4 and surrounds the forming core 41. The attachment part 41g of the core 41 can be connected to the basic part 41f of the core at a desired spot but, generally, it is most preferable to form the core 41 so that the attachment part 41f constitutes the forming part of the core, i.e., the part that is fitted into the mould cavity 71, when the cardboard blank K is pressed to shape in the manner shown in FIGS. 3A-3C. The face 411a of the attachment part then functions as the face 41a of the core and it will be flush with the seal surface 7a of the mould plate 7 or slightly above the same in the direction of the movable mould half 10, when the core 41 is pressed to the mould cavity 71. The attachment part 41g of the core 41 is connected to the basic part 41f of the core by an appropriate fastening, such as a screw fastening. As the joint between the basic part 41f and the attachment part 41g of the core is not copied to the plastic rim of the container that is made, the mutual fastening of the attachment part 41g and the basic part 41f of the core can also be implemented by other fastening methods that are known by those skilled in the art. In the pair of forming core and mould cavity according to FIG. 4, a recess 710 that corresponds to the projection 410 of the core attachment part 41g is now formed on the bottom 71b of the mould cavity 71 of the mould plate 7. In that case, the insert of the mould cavity 71 is, in fact, an insert, which is removed from the bottom 71b of the mould cavity and which can be reconnected to the bottom 71b, when a mould system according to FIG. 5 is to be formed, wherein the bottom 71b of the mould cavity 71 is flat and by which one-sided shapes are created to the body 58 of the container part that is formed from the cardboard blank. When the pair of forming core and mould cavity according to FIG. 4 is used in the manufacture of the container 500 in the manner illustrated earlier by FIGS. 1-3, the projection 410 of the core attachment part 41g is pressed to the bottom 71b of the mould cavity 71 at the compression stage, i.e., in the work phase shown above in FIGS. 3B and 3C. The projection 410 then pushes the cardboard blank that is between the forming core 41 and the mould cavity 71 towards the recess 710, which is on the bottom 71b of the mould cavity 71 and has the size and shape of the said projection (in fact, the recess 710 is wider by about the thickness of the cardboard, so that the cardboard fits between the core and the bottom of the mould cavity). Thus, an inner recess of the container is copied to the inner surface of the bottom 57 of the container 500 that is made; and a corresponding bulge that extends downwards from the rest of the plane of the bottom outer surface is copied to the outer surface of the bottom.

The forming core 41 shown in FIG. 5 and the mould cavity 71 opposite to it differ from the forming core according to FIG. 4 and the moulding cavity opposite the same only in that the bottom 71b of the mould cavity is now even, i.e., there is no insert 710 or the insert 710 of the bottom of the mould cavity is re-attached to the bottom 71b. When the pair of forming core and mould cavity according to FIG. 5 is used in the manufacture of the container 500, the projection 410 of the core attachment part 41g is pressed to the bottom 71b of the mould cavity 71 at the compression stage and the projection 410 pushes the cardboard blank K that is between the forming core 41 and the moulding cavity 71 towards the flat bottom 71b of the mould cavity 71 in the manner illustrated in FIGS. 3A-3B. The recess is copied only to the inner surface of the bottom 57 of the container 500 that is made and the outer surface of the bottom 71b remains flat.

FIGS. 6A and 6B show another preferred embodiment of the invention. FIG. 6A shows the collar ring and the core 10 of the rear mould 10, which provides the plastic partitions, which are attached to the walls and bottom of the container bodies 58 that are provided by the method described earlier in connection with FIGS. 1-3. These partitions are provided by the forming core 41, its forming part (the part between the face 41a and the outer surface 41b of the core, i.e., the end of the core on the side of the mould cavity), which is fitted inside the mould cavity at the compression stage of the cardboard, or the entire forming core 41 being divided into two or more sections by a recess 420 running between the sections. Then, the core 41 itself can either be formed similarly to what is shown in FIGS. 4 and 5, whereby the core 41 consists of the basic part 41f that is attached to the core plate 4 and the attachment part 41g that is connected on top of the basic part. The said recesses 420 for the partition(s) V are then formed to the attachment part 41g. Another alternative is the method shown in FIG. 6A, wherein the entire two-piece forming core 41 that is located on the core plate 4 is arranged to be replaced.

The rear mould 10 shown in FIG. 6A comprises the forming core 41 and the concentric collar ring 4 that moves around and with respect the same. In the middle of the lateral direction of the forming core 41, a recess 420 in the longitudinal direction of the forming core is made, facing the end 4b of the core on the side of the mould cavity, i.e., the end that is pressed against the bottom of the mould cavity and the cardboard that lies on the bottom. The recess runs from one edge to the other in the lateral direction of the core and it has the shape and depth of the partition V that is formed on the cardboard bottom 57 of the container 500. In FIG. 6A, the entire core 41, in the lateral direction, is divided into two identical parts 41′ and 41′, and the recess 420 that runs between the parts in the longitudinal direction of the core has a shape and dimensions that correspond to those of the partition V that is to be made in the container 500. A container 500, which is produced by the rear mould 10 that comprises such a divided (forming) core 41, and the partition V in it, are shown in FIG. 6B. The longitudinal direction of the core herein refers to the direction that is perpendicular to the plane defined by the core plate 4 and, at the same time, the moving direction of the core, when it is moved into the mould cavity. The lateral direction of the core refers to the direction of the plane of the core plate.

The exemplary container shown in FIG. 6B comprises a body 58 that is pressed from the cardboard blank. The body 58 consists of a rectangular bottom 57, to which walls 59 that encircle the bottom 57 and extend upwards from the bottom plane are connected. A flange-like plastic rim 50 extending outwards encircles the upper edge of the walls 59 that are pressed from cardboard. In the lateral direction, the container 500 is divided in two by the plastic partition V that is attached to the walls 59 and the bottom 57. The partition is made after the cardboard K is pressed to its shape, the body 58, by the work phases shown earlier in connection with the description of FIGS. 3A-3C.

The partition V is formed simultaneously with the edge flange (unless, for a special reason, it is to be made separately, e.g., when making the partition and the flange from different materials). The cavity for the partition can be formed (if the cavity is not ready in the core, it can be made by pulling a piece out of the way, e.g., by means of compressed air before casting) before the edge flange 50 is cast on the container 500 (the work phase according to FIG. 3D). The partition V is made by first pressing the cardboard blank into the form of the intended container between the core and the mould cavity. After this, molten plastic is supplied into the recess 420 of the core 41, which extends to the cardboard blank that is pressed to the bottom of the mould cavity, e.g., through casting conduits that are arranged through the frame of the front mould, in a manner known as such. The recess 420 of the core is perpendicular to the plane defined by the bottom of the mould cavity and runs in the lateral direction of the core 41 from one edge to the other, which is why the partition that is formed will run across the container and be perpendicular to the container bottom 57.

Only a few embodiments of the invention are described above and it is obvious to those skilled in the art that the invention can be implemented in various other ways within the scope of the invention disclosed in the claims.

Thus, in the embodiments of the invention according to FIGS. 4, 5 and 6A, the entire core 4 on the core plate 41 can also be replaced. In that case, the projection 410 of the core 41, which is used as insert in FIGS. 4 and 5, is attached to the outer edge 41b of the forming core 41. Similarly, even though in the embodiment of the invention illustrated in FIGS. 4 and 5, the attachment part 41g of the core 41 is provided with the projection 410 and the bottom 71b of the mould cavity 71 is provided with the recess 710 that corresponds to the said projection 410, the same end result is obtained by providing the bottom 71b of the mould cavity 71 with an upwards extending projection and the outer edge 411b of the attachment part 41g of the mould core 41 with a corresponding recess.

Several sections of different heights that are provided with partitions can also be made in the same cardboard-based container by a core similar to FIG. 6A, which comprises several recesses 420 of different heights.

The walls 59 of the container 500 can also be provided with various functional or decorative, one or two-sided embossed or inlaid shapes. In that case, the bulges and recesses are placed on the walls of the core 41 or its attachment part 41g and/or on the walls 71a of the mould cavity instead of the outer end of the core and the bottom 71b of the moulding cavity.

1. A mould system (1) for producing a partition in a cardboard-based container, the mould system comprising a movable mould half (10) and a stationary mould half (20), which are located opposite to each other, the mould system (1) enabling the manufacture of a container (500), which comprises a bottom (57) that is pressed from a cardboard blank and walls (59) that are connected to the bottom, and a rim (50) that is at least partly cast of plastic and connected to the upper edge of the wall, encircling the walls, whereby the mould half (10) that is movable with respect to the stationary mould half (20) includes at least a core plate (4) provided with a core (41), a plate-like seal ring (5), which is movable with respect to the core (41), comprises a seal surface (5a) and surrounds the core (41), and a collar ring (6), which can be fitted between the core (41) and the seal ring (5), and by which the rim (50) can be made on the container and which is movable with respect to both the seal ring (5) and the core (41), and the stationary mould half (40) includes at least a mould plate (7) that is provided with a mould cavity (71) and a seal surface (7a), characterized in that in the mould system (1), at least one recess (420) is formed in the core (41), which recess is in the longitudinal direction of the core and divides, in the lateral direction, the core (41) or the forming part of the core (41) that is pressed to the mould cavity, and which faces the end (41b) of the core on the side of the mould cavity and enables the formation of a plastic partition (V) that extends upwards from the bottom (57) of the cardboard-based container (500), when the said recess (420) is placed against the cardboard blank that is on top of the mould cavity.

2. A mould system according to claim 1, characterized in that the core (41) consists of a basic part (41f), which is attached to the core plate (4), and an attachment part (41g), which is connected to the said basic part and comprises at least one recess (420) that runs in the longitudinal direction of the core (41) and extends to the end (41b) of the core on the side of the mould cavity, so that when the forming part of the core (41) is fitted against the cardboard blank that lies on the bottom of the mould cavity (71), the said cavity (420) of the core enables the casting of at least one plastic partition (V), which is supported on the intended cardboard bottom (57) of the container (500).

3. A mould system (1) according to claim 2, characterized in that the forming part of the core (41) consists of two separate parts (41′, 41″), between which at least one recess (420) in the longitudinal direction of the core runs, its depth being the same as the height of the partition (V) that extends upwards from the bottom (57) of the container (500), as viewed from the bottom of the container, the recess (420) facing the end (41b) of the core (41) that is pressed against the bottom of the mould cavity.

4. A mould system according to any of the preceding claims, characterized in that a number of recesses (420), which have different depths in the longitudinal direction of the core, face the end (41b) of the core (41) that is pressed against the bottom of the mould cavity, enabling the making of partitions (V) with different heights on the bottom of the container (500).

5. A method of manufacturing a container (500) that has a cardboard-based body (58) by the mould system according to claim 1, characterized in that a cardboard blank (K) is pressed between the forming core (41) and the mould cavity (71) to produce the container bottom (57) and walls (59) that encircle the bottom, after which the flange-like rim (50), which encircles the walls and at least partly consists of plastic, is formed by casting on the upper edge of the walls and, furthermore, a partition that attaches to the body of the container (500) is made by introducing molten plastic into the cavity (420) of the core (41) that extends to the cardboard blank that is pressed to the bottom of the mould cavity, through casting conduits that are arranged through the body of the front mould.

6. A method according to claim 5, characterized in that the cardboard blank (K) is retained between the seal surface (5a) of the seal ring and the seal surface (61a) of the collar ring and the seal surface (7a) of the mould plate opposite to the same at least until the cardboard blank (k) has slid into the mould cavity (71), and a casting cavity is not provided in the mould system until after this for forming the flange-like rim (50) that encircles the container walls and at least partly consists of plastic.
